(19) United States
(12) Patent Application Publication
(10) Pub. No.: US 2025/0050950 A1
(43) Pub. Date: Feb. 13, 2025

(54) STRUCTURE OF THE VEHICLE BODY

(71) Applicants: Hyundai Motor Company, Seoul (KR); Kia Corporation, Seoul (KR)

(72) Inventor: Hyun Sik Kim, seoul (KR)

(21) Appl. No.: 18/593,022

(22) Filed: Mar. 1, 2024

(30) Foreign Application Priority Data
Aug. 10, 2023 (KR) 10-2023-0104497

(51) Int. Cl. B62D 21/15

(52) U.S. Cl. CPC B62D 21/155

(57) ABSTRACT

An embodiment structure of a vehicle body includes a sub-frame coupled to opposite sides of the vehicle body, wherein the sub-frame includes sub-frame side members coupled to the opposite sides of the vehicle body, respectively, first crash boxes each coupled to an end of a corresponding one of the sub-frame side members, second crash boxes each spaced apart from a corresponding one of the first crash boxes inwardly in a width direction of the vehicle body and coupled to a corresponding one of the sub-frame side members, and a sub-frame back beam disposed at the first crash boxes and at the second crash boxes.

### CROSS-REFERENCE TO RELATED APPLICATIONS

This application claims the benefit of Korean Patent Application No. 10-2023-0104497, filed on Aug. 10, 2023, which application is hereby incorporated herein by reference.

### TECHNICAL FIELD

The present disclosure relates to a structure of a vehicle body.

### BACKGROUND

With the recent development of electric vehicles, the weight of the vehicle is increasing due to high-voltage battery parts loaded into the vehicle. Because the high-voltage battery parts are mounted in a limited floor package space, an impact load that side members, constituting the vehicle body, have to bear in the event of a collision increases. Furthermore, the structure of the vehicle body reduces crumple zones.

In order to protect the parts of the vehicle, such as a high voltage battery, the structure of the vehicle body maintains, as much as possible, a typical skeleton of a vehicle, and reinforces rigidity against collision by installing a reinforcing member inside the side member.

However, the structure of the vehicle body has a problem in that manufacturing cost and weight of the vehicle increase due to the reinforcing member being locally excessively mounted. Moreover, because the reinforcing member is installed inside the side member, the rigidity at opposite sides of the structure where the side member is installed is substantially increased, but the rigidity at an area of the structure where the side member is not installed is decreased. Therefore, when an impact load is applied to the area where the side member is not installed, it is difficult to protect the parts mounted at the floor of the vehicle.

The above information disclosed in this background section is only for enhancement of understanding of the background of embodiments of the present disclosure, and therefore it may contain information that does not form the related art that is already known to a person of ordinary skill in the art.

### SUMMARY

The present disclosure relates to a structure of a vehicle body. Particular embodiments relate to a structure of a vehicle body including a plurality of crash boxes disposed to be spaced apart from one another at the front of the vehicle body.

Embodiments of the present disclosure have been made in an effort to solve problems associated with the related art, and an embodiment of the present disclosure provides a sub-frame structure coupled to a side member.

Another embodiment of the present disclosure provides a first crash box and a second crash box, which constitute a sub-frame structure, configured to absorb impact by being coupled to a sub-frame back beam.

The embodiments of the present disclosure are not limited to the foregoing, and other embodiments of the present disclosure not mentioned herein may be understood based on the following description, and may be understood more clearly through the described embodiments of the present disclosure. In addition, the embodiments of the present disclosure may be realized by means and combinations thereof indicated in the claims.

One embodiment of the present disclosure provides a structure of a vehicle body including side members elongated in a longitudinal direction at opposite sides of the vehicle body and a sub-frame coupled to the side members. Here, the sub-frame may include sub-frame side members coupled to the side members disposed at the opposite sides of the vehicle body, respectively, first crash boxes each coupled to an end of a corresponding one of the sub-frame side members, second crash boxes each spaced apart from a corresponding one of the first crash boxes inwardly in a width direction and coupled to a corresponding one of the sub-frame side members, and a sub-frame back beam disposed at outer ends of the first crash boxes and at outer ends of the second crash boxes.

In a preferred embodiment, the front and the rear of the sub-frame side member may be coupled to the side member.

In another preferred embodiment, the structure of the vehicle body may include front mounting members each disposed between the front of a corresponding one of the side members and the front of a corresponding one of the sub-frame side members coupled thereto.

In still another preferred embodiment, the sub-frame side member may include a front curved portion curved outward at the front of the sub-frame side member coupled to the sub-frame back beam and a rear curved portion curved outward at the rear of the sub-frame side member coupled to a rear vehicle body.

In yet another preferred embodiment, the structure of the vehicle body may include a sub-frame front cross member disposed at the front curved portion and a sub-frame rear cross member disposed at the rear curved portion.

In still yet another preferred embodiment, the second crash box may be disposed to be coupled to an inner end of the front curved portion.

In a further preferred embodiment, the structure of the vehicle body may include a back beam disposed at ends of the side members.

In another further preferred embodiment, an end of the back beam in the longitudinal direction and an end of the sub-frame back beam in the longitudinal direction may be on the same line.

In still another further preferred embodiment, the back beam may have a curvature in the width direction identical to that of the sub-frame back beam.

Another embodiment of the present disclosure provides a structure of a vehicle body including side members elongated in a longitudinal direction at opposite sides of the vehicle body and a sub-frame coupled to the side members. Here, the sub-frame may include sub-frame side members coupled to the side members disposed at the opposite sides of the vehicle body, respectively, first crash boxes each coupled to an end of a corresponding one of the sub-frame side members, second crash boxes each spaced apart from a corresponding one of the first crash boxes inwardly in a width direction, disposed to be parallel with the first crash boxes, and coupled to a corresponding one of the sub-frame side members, and a sub-frame back beam disposed at outer ends of the first crash boxes and at outer ends of the second crash boxes.

In a preferred embodiment, the front and the rear of the sub-frame side member may be coupled to the side member.

In another preferred embodiment, the structure of the vehicle body may include front mounting members each disposed between the front of a corresponding one of the side members and the front of a corresponding one of the sub-frame side members coupled thereto.

In still another preferred embodiment, the sub-frame side member may include a front curved portion curved outward at the front of the sub-frame side member coupled to the sub-frame back beam and a rear curved portion curved outward at the rear of the sub-frame side member coupled to a rear vehicle body.

In yet another preferred embodiment, the structure of the vehicle body may include a sub-frame front cross member disposed at the front curved portion and a sub-frame rear cross member disposed at the rear curved portion.

In still yet another preferred embodiment, the second crash box may be disposed to be coupled to an inner end of the front curved portion.

In a further preferred embodiment, the structure of the vehicle body may include a back beam disposed at ends of the side members.

In another further preferred embodiment, an end of the back beam in the longitudinal direction and an end of the sub-frame back beam in the longitudinal direction may be on the same line.

In still another further preferred embodiment, the back beam may have a curvature in the width direction identical to that of the sub-frame back beam.

Other aspects and preferred embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of embodiments of the present disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the embodiments of the present disclosure, and wherein:

FIG. 1 is a perspective view of the structure of a vehicle body as an embodiment of the present disclosure;

FIG. 2 is a bottom view of the structure of a vehicle body as an embodiment of the present disclosure;

FIG. 3 is a side view of the structure of a vehicle body as an embodiment of the present disclosure;

FIG. 4 is a side cross-sectional view of the structure of a vehicle body as an embodiment of the present disclosure;

FIG. 5A illustrates the direction of energy movement generated by a longitudinal impact on the structure of a vehicle body as an embodiment of the present disclosure; and

FIG. 5B illustrates a sub-frame structure in which an impact is absorbed when collision with a small overlap occurs to the structure of a vehicle body as an embodiment of the present disclosure.

It should be understood that the appended drawings are not necessarily to scale, presenting a somewhat simplified representation of various preferred features illustrative of the basic principles of embodiments of the present disclosure. The specific design features of embodiments of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawings.

### DETAILED DESCRIPTION OF ILLUSTRATIVE EMBODIMENTS

Hereinafter, embodiments of the present disclosure are described in detail with reference to the accompanying drawings. The embodiments of the present disclosure may be modified into various forms, and the scope of the embodiments of the present disclosure should not be construed as being limited to the following embodiments. The embodiments are provided to more completely explain the present disclosure to those skilled in the art.

In addition, terms such as “ . . . frame,” “ . . . member,” “ . . . box,” “ . . . beam,” etc. used in this specification each refer to a unit that processes at least one function or operation, and may be implemented as hardware or a combination thereof.

The terminology used herein is for the purpose of describing particular embodiments only and is not intended to be limiting. A singular representation may include a plural representation unless it represents a definitely different meaning from the context.

It should be understood that, although the terms “first,” “second,” etc. may be used herein to describe various similar elements, these elements should not be construed as being limited by these terms. These terms are only used to distinguish one element from another.

Moreover, in this specification, referring to the direction of the components as “longitudinal direction” or “width direction” means a direction with respect to the vehicle, and the longitudinal direction and the width direction mean directions perpendicular to each other on one plane. In addition, the longitudinal direction of the vehicle means a front-rear direction and the width direction of the vehicle means a left-right direction.

Furthermore, referring to the direction of the components in this specification as “front” or “rear” means forward or rearward on the drawings and is not limited to the order thereof.

Hereinafter, embodiments will be described in detail with reference to the accompanying drawings, and in the description given with reference to the accompanying drawings, the same or corresponding components are assigned the same reference numerals, and a description thereof will not be repeated.

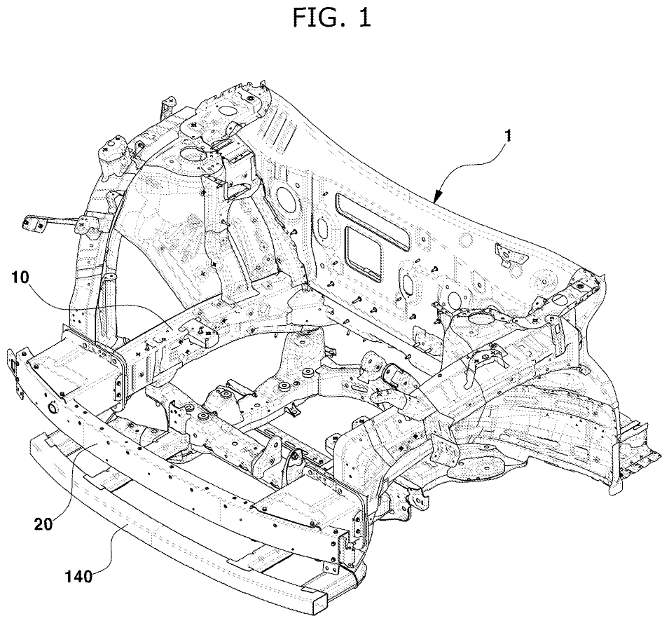

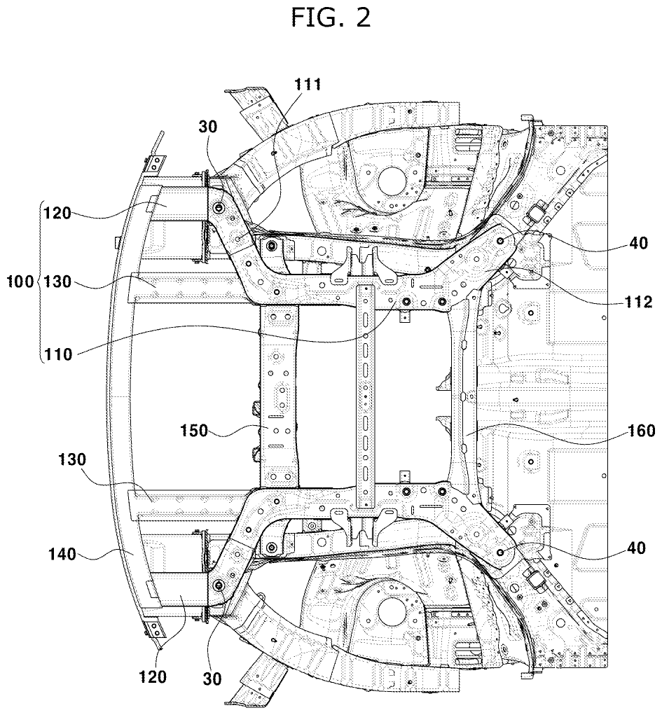

FIGS. 1 to 3 are a perspective view, a bottom view, and a side view, respectively, illustrating the coupling relationship in the structure of a vehicle body 1 as an embodiment of the present disclosure.

As illustrated in the drawings, the structure of the vehicle body 1 includes side members 10 separated from each other and disposed in the longitudinal direction of the vehicle at opposite sides of the structure, respectively, and a sub-frame 100 coupled to the side members 10. The sub-frame 100 is disposed at a vertically lower end of the structure with respect to the side members 10 and includes at least two mounting areas. Furthermore, the side members 10 each have a longitudinal end including a back beam 20.

With the sub-frame 100 disposed at vertically lower ends of the side members 10, the sub-frame 100 includes sub-frame side members 110 coupled to the side members 10 disposed in the longitudinal direction at the opposite sides of the structure, respectively, first crash boxes 120 each disposed at an end of a corresponding one of the sub-frame side members 110 and elongated in the longitudinal direction of the vehicle, and second crash boxes 130 each spaced apart from a corresponding one of the first crash boxes 120 inwardly of the vehicle and coupled to a front curved portion 111 of a corresponding one of the sub-frame side members 110. The first crash box 120 and the second crash box 130 may be disposed to be parallel with each other with respect to the width direction of the vehicle and may be disposed to be horizontal with respect to the vertical direction. Furthermore, the sub-frame 100 includes a sub-frame back beam 140 coupled to ends of the first crash boxes 120 and to ends of the second crash boxes 130.

The first crash box 120 and the second crash box 130 have relatively low rigidity compared to the chassis constituting the sub-frame 100, and when an impact is applied in the longitudinal direction of the vehicle, the first crash box 120 and the second crash box 130 absorb the impact before the other components constituting the sub-frame 100 do. Therefore, the sub-frame back beam 140 may be dented inward along the damaged area of the first crash box 120 and the second crash box 130.

The first crash box 120 and the second crash box 130 have defined therebetween a predetermined space, allowing the sub-frame back beam 140 to be dented into the space in response to an impact applied thereto. Therefore, even when an impact is applied in the longitudinal direction of the vehicle or applied at a predetermined angle in the longitudinal direction, the sub-frame back beam 140 may be dented into the space defined between the first crash box 120 and the second crash box 130 and/or a space defined between two second crash boxes 130 separated from each other.

The sub-frame side member 110 includes the front curved portion 111 curved outward at the front of the sub-frame side member 110 coupled to the sub-frame back beam 140 and a rear curved portion 112 curved outward at the rear of the sub-frame side member 110 coupled to the side member 10 at the rear vehicle body 1. The second crash box 130 is disposed to be elongated forward at an inner end of the sub-frame side member 110 where the front curved portion 111 starts to curve, and the first crash box 120 is disposed at an end of the front curved portion 111. The front curved portion 111 includes a front coupling portion 30, and the rear curved portion 112 includes a rear coupling portion 40. Here, the front coupling portion 30 and the rear coupling portion 40 are coupled to the side member 10. More particularly, the structure includes front mounting members 200 each disposed adjacent to a corresponding one of the front curved portions 111 and coupled to a corresponding one of the sub-frame side members 110 by being elongated vertically downward from a corresponding one of the side members 10.

The front mounting member 200 is disposed between an external surface of the side member 10 and an upper surface of the sub-frame side member 110.

Furthermore, the front mounting member 200 protrudes in a width direction of the side member 10 and is coupled to the sub-frame side member 110.

More particularly, the sub-frame side member 110 protrudes outward such that the sub-frame side member 110 has the front coupling portion 30 protruding more outward than the rear coupling portion 40, and thus the front coupling portion 30 coupled to the front mounting member 200 protrudes more outward than the side member 10.

A front end of the sub-frame back beam 140, integrally coupled to the ends of the first crash boxes 120 and to the ends of the second crash boxes 130, may be on the same line as a front end of the back beam 20, and the sub-frame back beam 140 may be disposed lower than the back beam 20. Furthermore, the back beam 20 and the sub-frame back beam 140 may be elongated in the width direction of the vehicle and have the same curvature when viewed from the bottom.

Furthermore, the sub-frame side members 110 disposed at the opposite sides, respectively, include a sub-frame front cross member 150 elongated in the width direction of the vehicle with opposite ends thereof disposed at the starting points of the front curved portions 111, respectively, and a sub-frame rear cross member 160 elongated in the width direction of the vehicle with opposite ends thereof coupled to the inner starting points of the rear curved portions 112, respectively.

The sub-frame front cross member 150 and the sub-frame rear cross member 160, which are spaced apart from each other in the front-rear direction and configured to reinforce lateral rigidity, are coupled to parts, such as a floor, a fuel tank, and a battery, to protect the same.

Moreover, the sub-frame front cross member 150 and the sub-frame rear cross member 160 coupled to the sub-frame side members 110 may perform a function of reinforcing lateral rigidity in response to an impact applied to the front of the structure.

The sub-frame front cross member 150 and the sub-frame rear cross member 160 are integrated with the sub-frame side members 110 and are parallel with each other. Furthermore, an area of the sub-frame side member 110 where the sub-frame front cross member 150 is disposed includes the front curved portion 111. Therefore, the second crash box 130, the front mounting member 200, and the sub-frame front cross member 150 may be integrally coupled to one another at an inner end of the front curved portion 111.

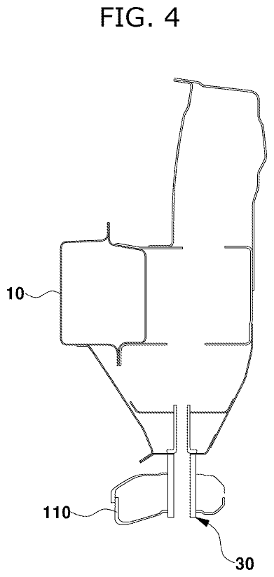

FIG. 4 is a side cross-sectional view of an area where the side member 10 and the sub-frame 100 are coupled to each other, as an embodiment of the present disclosure.

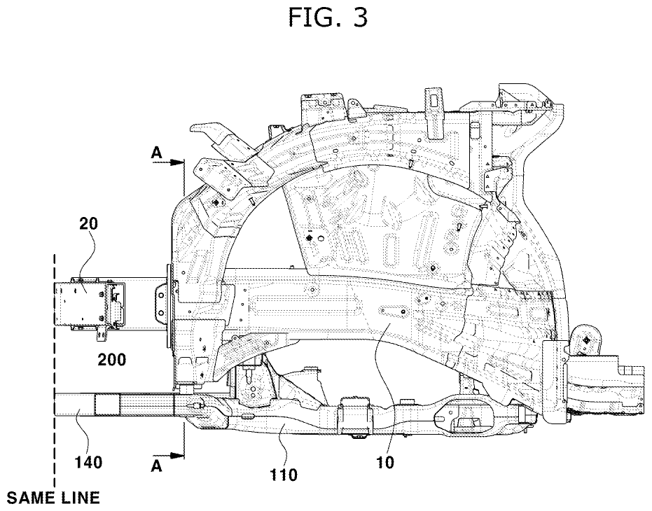

FIG. 4 is the side cross-sectional view taken along line A-A of FIG. 3, illustrating the sub-frame side member 110 coupled to a lower end of the side member 10.

The side member 10 and the sub-frame side member 110 are coupled to each other using the front mounting member 200. The front mounting member 200 is coupled to the lower end of the side member 10, and the sub-frame side member 110 is fixed to a lower end of the front mounting member 200. More particularly, the front mounting member 200 and the sub-frame side member 110 are coupled to each other through the front coupling portion 30 of the sub-frame side member 110. In other words, the lower end of the front mounting member 200 may be coupled to the front coupling portion 30 passing through the sub-frame side member 110, and an upper end of the front mounting member 200 may surround at least a portion of a side surface of the side member 10.

Furthermore, a width of the front mounting member 200 where the front mounting member 200 is coupled to the external surface of the side member 10 is greater than a width of the front mounting member 200 where the front mounting member 200 is coupled to the sub-frame side member 110. In other words, the front mounting members 200 are curved to be adjacent to each other in a vertically downward direction.

The rear coupling portion 40 is directly coupled to the side member 10, and the front coupling portion 30 allows the sub-frame side member 110 to be coupled to the side member 10 through the front mounting member 200, and as illustrated in FIG. 3, the sub-frame side member 110 is disposed in a direction parallel with the side member 10.

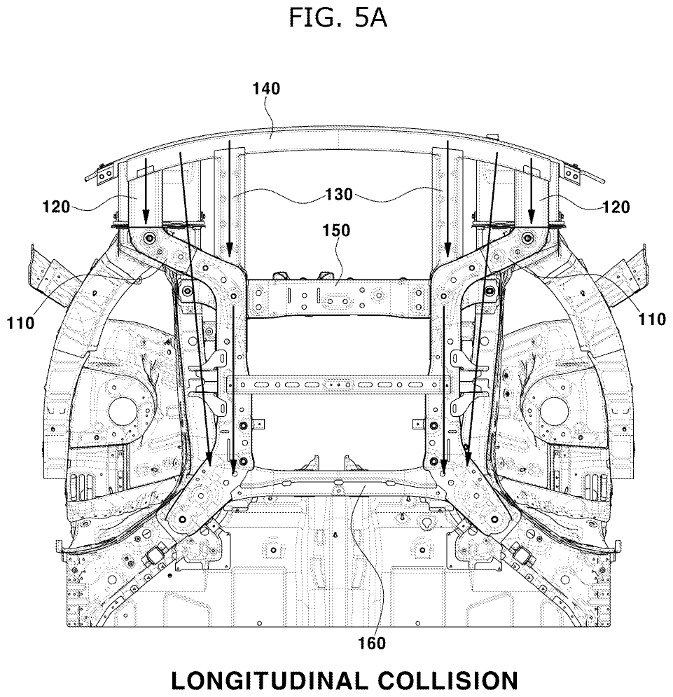

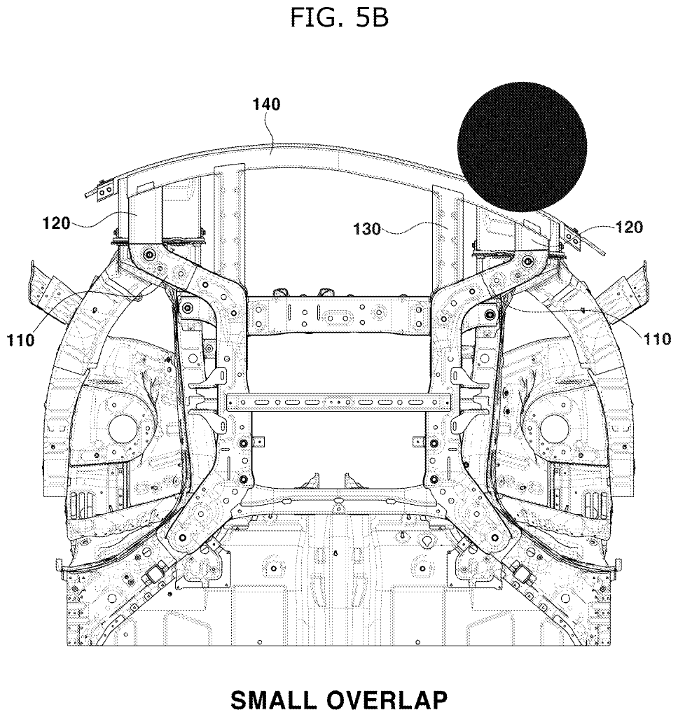

As an embodiment of the present disclosure, FIG. 5A illustrates the direction of an impact applied to the vehicle body 1 when the impact is applied to the back beam 20 and the sub-frame back beam 140, both disposed at one end of the vehicle body 1.

As illustrated in the drawing, when an impact in the longitudinal direction of the vehicle is applied to the back beam 20 and the sub-frame back beam 140, both disposed at an external side of the structure of the vehicle body 1, the impact is applied along the first crash boxes 120 and the second crash boxes 130.

Moreover, the impact applied to the sub-frame back beam 140 passes through the first crash boxes 120 and the second crash boxes 130 and moves along the sub-frame side members 110, and the impact applied to the back beam 20 is transmitted in the longitudinal direction along the side members 10 to the vehicle body 1.

Furthermore, because the back beam 20 and the sub-frame back beam 140 are disposed at the same position at the end of the vehicle body 1, the impact in the longitudinal direction may be applied to the side members 10 and to the sub-frame 100, simultaneously, in the vertical direction.

Therefore, the impact applied in the longitudinal direction to the structure of the vehicle body 1 according to embodiments of the present disclosure is distributed to the sub-frame 100 and the side members 10 disposed at different heights.

FIG. 5B illustrates the structure of the vehicle body 1 when an impact with a small overlap is applied thereto.

As illustrated in the drawing, when an impact is applied from the top right in the drawing, a first crash box 120 adjacent to the position where the impact is applied is damaged, and the sub-frame back beam 140 is dented into the space defined between the first crash box 120 and the second crash box 130.

Furthermore, an impact applied to the sub-frame side member 110 in response to an impact applied in the width direction is distributed through the sub-frame front cross member 150 disposed at the front curved portion 111 and the sub-frame rear cross member 160 disposed at the rear curved portion 112.

As illustrated in FIGS. 5A and 5B, in response to the impact applied in the longitudinal direction of the vehicle, the first crash boxes 120 and the second crash boxes 130 primarily absorb the impact, and the impact transmitted therethrough is distributed to the vehicle through the sub-frame side members 110 and the side members 10.

Furthermore, in response to the impact in the width direction, the sub-frame front cross member 150 and the sub-frame rear cross member 160 provide lateral rigidity and distribute the impact in the width direction to the opposite sides.

As is apparent from the above description, embodiments of the present disclosure may obtain the following effects by the configuration, combination, and operation relationship described above with the present embodiments.

Embodiments of the present disclosure provide a crash box structure capable of absorbing longitudinal impact energy generated by a collision on a vehicle using the structure of the vehicle body including a sub-frame.

Furthermore, embodiments of the present disclosure provide a sub-frame structure to absorb impact in response to a collision with a small overlap.

The detailed description is merely illustrative of exemplary embodiments of the present disclosure. In addition, the above description shows and describes preferred embodiments of the present disclosure, but embodiments of the present disclosure can be used in various other combinations, modifications, and environments. In other words, changes or modifications are possible within the scope of the idea of the embodiments of the disclosure disclosed herein, the scope of equivalents to the described disclosure, and/or the scope of skill or knowledge in the art. The embodiments describe the best state for implementing the technical idea of embodiments of the present disclosure, and various changes required for specific application fields and uses of the embodiments of the present disclosure are possible. Therefore, the detailed description of exemplary embodiments of the present disclosure is not intended to limit the embodiments of the present disclosure to the disclosed embodiments. Also, the appended claims should be construed to include other embodiments.

What is claimed is:

1. A structure of a vehicle body, the structure comprising:
a sub-frame coupled to opposite sides of the vehicle body, wherein the sub-frame comprises:
sub-frame side members coupled to the opposite sides of the vehicle body, respectively;
first crash boxes each coupled to an end of a corresponding one of the sub-frame side members;
second crash boxes each spaced apart from a corresponding one of the first crash boxes inwardly in a width direction of the vehicle body and coupled to a corresponding one of the sub-frame side members; and
a sub-frame back beam disposed at the first crash boxes and at the second crash boxes.

2. The structure of claim 1, further comprising side members elongated in a longitudinal direction of the vehicle body at the opposite sides of the vehicle body and coupled to the sub-frame.

3. The structure of claim 2, further comprising front mounting members each disposed between a corresponding one of the side members and a corresponding one of the sub-frame side members.

4. The structure of claim 3, wherein each of the front mounting members is coupled to an external surface of the corresponding one of the side members and to a front of the corresponding one of the sub-frame side members.

5. The structure of claim 1, wherein each of the sub-frame side members comprises:
a front curved portion curved outward at a front of the sub-frame side member coupled to the sub-frame back beam; and
a rear curved portion curved outward at a rear of the sub-frame side member coupled to a rear vehicle body.

6. The structure of claim 5, further comprising:
a sub-frame front cross member disposed at the front curved portion; and
a sub-frame rear cross member disposed at the rear curved portion.

7. The structure of claim 5, wherein the sub-frame front cross member and the sub-frame rear cross member extend in the width direction of the vehicle body between the opposite sides of the vehicle body.

8. The structure of claim 5, wherein each of the second crash boxes is disposed to be coupled to an inner end of the front curved portion of the corresponding one of the sub-frame side members.

9. A structure of a vehicle body, the structure comprising:
a sub-frame coupled to opposite sides of the vehicle body, wherein the sub-frame comprises:
sub-frame side members coupled to the opposite sides of the vehicle body, respectively;
first crash boxes each coupled to an end of a corresponding one of the sub-frame side members;
second crash boxes each spaced apart from a corresponding one of the first crash boxes inwardly in a width direction of the vehicle body and coupled to a corresponding one of the sub-frame side members; and
a sub-frame back beam disposed at the first crash boxes and at the second crash boxes;
side members elongated in a longitudinal direction of the vehicle body at the opposite sides of the vehicle body and coupled to the sub-frame; and
a back beam disposed at a front of the side members.

10. The structure of claim 9, wherein an end of the back beam in the longitudinal direction of the vehicle body and an end of the sub-frame back beam in the longitudinal direction of the vehicle body are on a same line.

11. The structure of claim 9, wherein the back beam has a curvature in the width direction of the vehicle body identical to that of the sub-frame back beam.

12. The structure of claim 9, further comprising front mounting members each disposed between a corresponding one of the side members and a corresponding one of the sub-frame side members.

13. The structure of claim 12, wherein each of the front mounting members is coupled to an external surface of the corresponding one of the side members and to a front of the corresponding one of the sub-frame side members.

14. The structure of claim 9, wherein each of the sub-frame side members comprises:
a front curved portion curved outward at a front of the sub-frame side member coupled to the sub-frame back beam; and
a rear curved portion curved outward at a rear of the sub-frame side member coupled to a rear vehicle body.

15. The structure of claim 14, further comprising:
a sub-frame front cross member disposed at the front curved portion of each of the sub-frame side members; and
a sub-frame rear cross member disposed at the rear curved portion of each of the sub-frame side members.

16. The structure of claim 14, wherein the sub-frame front cross member and the sub-frame rear cross member extend in the width direction of the vehicle body between the opposite sides of the vehicle body.

17. The structure of claim 14, wherein each of the second crash boxes is disposed to be coupled to an inner end of the front curved portion of the corresponding one of the sub-frame side members.

18. A vehicle comprising:
a vehicle body comprising side members separated from each other in a width direction of the vehicle body and disposed in a longitudinal direction of the vehicle at opposite sides of the vehicle body and a back beam disposed at an end of the side members and extending in the width direction of the vehicle body;
a sub-frame disposed at an underside of the side members, wherein the sub-frame comprises:
sub-frame side members each coupled to a corresponding one of the side members;
first crash boxes each coupled to an end of a corresponding one of the sub-frame side members;
second crash boxes each spaced apart from a corresponding one of the first crash boxes inwardly in the width direction of the vehicle body and coupled to a corresponding one of the sub-frame side members; and
a sub-frame back beam disposed at the first crash boxes and at the second crash boxes, wherein an end of the back beam in the longitudinal direction of the vehicle body and an end of the sub-frame back beam in the longitudinal direction of the vehicle body are on a same line.

19. The vehicle of claim 18, wherein each of the sub-frame side members comprises:
a front curved portion curved outward at a front of the sub-frame side member coupled to the sub-frame back beam; and
a rear curved portion curved outward at a rear of the sub-frame side member coupled to a rear vehicle body.

20. The vehicle of claim 19, further comprising:
a sub-frame front cross member extending in the width direction of the vehicle and disposed at the front curved portion of each of the sub-frame side members; and
a sub-frame rear cross member extending in the width direction of the vehicle and disposed at the rear curved portion of each of the sub-frame side members.
